(19) United States
(12) Patent Application Publication
(10) Pub. No.: US 2001/0022670 A1
(43) Pub. Date: Sep. 20, 2001

(54) FACSIMILE APPARATUS WITH CONFIDENTIAL RECEPTION FUNCTION

(76) Inventor: KOICHI NAGATA, TOYOKAWA-SHI (JP)

Correspondence Address: SIDLEY AUSTIN BROWN & WOOD, 717 NORTH HARWOOD, SUITE 3400, DALLAS, TX, 75201, US

(21) Appl. No.: 09/108,715

(22) Filed: Jul. 1, 1998

(30) Foreign Application Priority Data
Jul. 3, 1997 (JP) 09-178115

(51) Int. Cl. H04N 1/00

(52) U.S. Cl. 358/405

(57) ABSTRACT

When confidential received image data is not retrieved from memory even when a predetermined time has passed, notification data indicating that the image data has not been retrieved is transmitted to the sender. The image data is deleted from a memory area upon completion of proper transmission of this notification data. Because image data deletion is carried out when transmission of notification data to the sender is complete, even if the confidential image data is deleted by the receiver, the sender is aware that the confidential image data was not received, and appropriate measures can be taken.

This application is based on application No. 9-178115 filed in Japan, the contents of which are hereby incorporated by reference.

### BACKGROUND OF THE INVENTION

1. Field of the Invention

The present invention concerns a facsimile apparatus provided with a confidential reception function.

2. Description of the Related Art

A facsimile apparatus provided with a confidential reception function is a conventionally known item. Such a confidential reception function immediately stores a received image in an image memory without performing printing. When a designated password is input subsequently, the stored confidential received image is printed and output. It is therefore possible to perform highly secure image transmission whereby persons other than those who know a password cannot view such image information.

Such a confidential reception function presents a problem in that the sender cannot confirm whether or not the received image has reached the recipient reliably. A problem also exists in that confidential images remain stored in memory as long as no password has been input, which restricts memory capacity.

As described in Japanese Registered Patent No. 2561076, a technology which notifies the sender that a confidential received image has not been retrieved from memory has been proposed in the form of a facsimile apparatus which resolves these several problems. In Japanese Laid-Open Patent Application HEI 6-70079, a technology is also proposed whereby confidential received image data can be assessed and deleted from memory based on data in an original document control data memory means.

The aforementioned facsimile apparatus notifies a sender that a confidential received image has not been retrieved from memory and deletes the unretrieved confidential received image from memory at the same time notification is made. Consequently, whether or the sender has properly received notification that a confidential received image has not been retrieved, an unretrieved confidential received image is simply deleted from memory after said notification is sent. A consequent problem exists in that, when a sender has not properly received notification that such an image has not been retrieved from memory, the sender cannot ascertain the fact that a confidential received image has been deleted from the receiver side memory without ever having been retrieved from memory.

### SUMMARY OF THE INVENTION

An object of the present invention is to offer a facsimile apparatus provided with a confidential reception function which deletes an image only when a sender has been reliably informed that confidential image data has not been retrieved by a receiver.

According to an aspect of the present invention, a facsimile apparatus provided with a confidential reception function, the facsimile apparatus comprises: a memory which stores received confidential image data; a notification data transmission means which transmits notification data indicating that the confidential image data has not been retrieved, in the event that the confidential image data stored in the memory has not been retrieved in a predetermined time; and a deletion means which deletes the confidential image data from the memory area in response to the completion of transmission of the notification data by the notification data transmission means.

According to another aspect of the present invention, A facsimile apparatus provided with a confidential reception function, the facsimile apparatus comprises: a memory which stores received confidential image data; an output means which outputs the stored confidential image data in response to input of a password by an operator; a determination means which determines whether or not the confidential image data has been output by the output means within a predetermined time after its reception; a notification data transmission means which transmits notification data indicating that confidential image data has not been output, in the event that the determination means has determined that output of the confidential image data has not been performed; a detection means which detects proper completion of transmission of the notification data; and a deletion means which deletes the confidential image data from the memory in response to detection by the detection means.

According to another aspect of the present invention, a managing method for a confidential received image in a facsimile apparatus provided with a confidential reception function, the managing method comprises the steps of: receiving confidential image data and storing the image data in a memory; monitoring whether the stored confidential image data has been output within a predetermined time after the reception; transmitting notification data indicating that output has not occurred, in the event that output has not occurred within the predetermined time; detecting proper completion of transmission of the notification data; and deleting the confidential image data from the memory in response to the detection.

Thus, when confidential received image data is not retrieved from memory even when a fixed interval has passed, data providing notification that said image data has not been retrieved is transmitted to the (original) sender, and said image data is deleted from a memory upon completion of proper transmission of this notification data. Because image data deletion is carried out when transmission of notification data to the sender is complete, even if confidential image data is deleted by the receiver, the sender is aware that said confidential image data was not received, and appropriate measures can be taken.

In a preferred embodiment herein, the notification data is so structured as to include part or all of the relevant confidential image data.

As a result, the sender can ascertain the fact that transmitted confidential image data was not retrieved at the receiver side and can also learn specifically what the unretrieved image data is, which allows the sender to take appropriate measures quickly.

These and other objects, advantages and features of the invention will become apparent from the following description thereof taken in conjunction with the accompanying drawings which illustrate specific embodiments of the invention.

### BRIEF DESCRIPTION OF THE DRAWINGS

In the following description, like parts are designated by like reference numbers throughout the several drawings.

FIG. 1 is a processing flowchart concerning deletion by a preferred embodiment of the present invention in the event that confidential received image data has not been retrieved;

FIG. 2 is an external oblique view of a facsimile apparatus provided with a confidential reception function according to a preferred embodiment of the present invention;

FIG. 3 is a component drawing of an operating panel on the facsimile apparatus pertaining to FIG. 2;

FIG. 4 is a component drawing of scanner elements provided internally in the facsimile apparatus pertaining to FIG. 2;

FIG. 5 is an internal block diagram concerning control of the facsimile apparatus pertaining to FIG. 2;

FIG. 6(a) is a processing flowchart concerning confidential transmission by the facsimile apparatus pertaining to FIG. 2;

FIG. 6(b) is a processing flowchart concerning confidential reception by the facsimile apparatus pertaining to FIG. 2;

FIG. 7 is a processing flowchart concerning telephone number recognition by the facsimile apparatus pertaining to FIG. 2;

FIG. 8 is a drawing illustrating calling telephone number display service using a public circuit pertaining to FIG. 5; and

FIG. 9 is a drawing illustrating a data sheet used for notification that a confidential received image has not been retrieved by means of the facsimile apparatus pertaining to FIG. 2.

### DESCRIPTION OF THE PREFERRED EMBODIMENTS

Preferred embodiments of the present invention are described below with reference to the drawings.

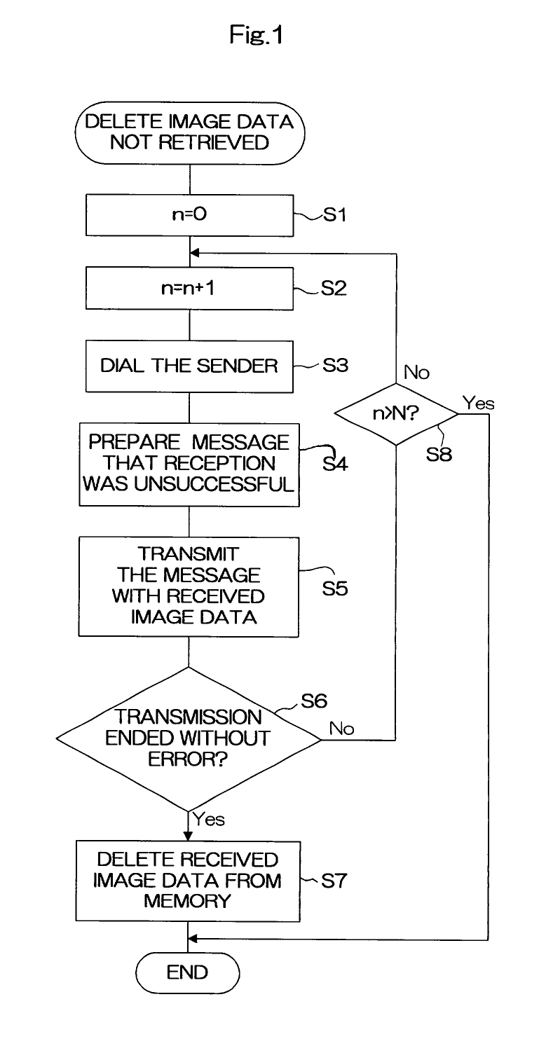

FIG. 1 is a processing flowchart concerning deletion by a preferred embodiment of the present invention in the event that confidential received image data has not been retrieved. The statement that image data has not been retrieved means that, on the receiving side, a password has not been input and a printout has not been made.

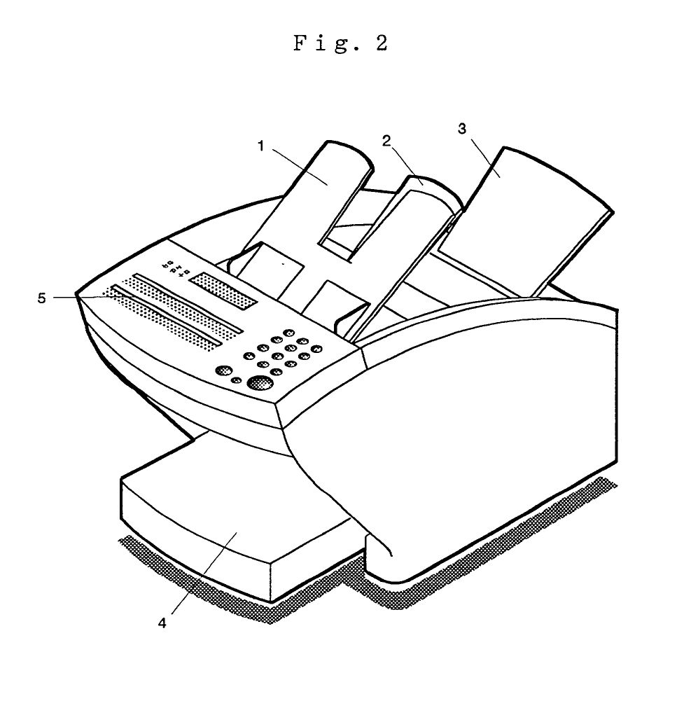

FIG. 2 is an external oblique view of a facsimile apparatus provided with a confidential reception function according to a preferred embodiment of the present invention. The facsimile apparatus in FIG. 2 includes original document supply tray 1 where original documents for transmission are placed, original document ejection tray 2 which receives original documents that are read by scanner elements described hereinafter and then ejected, recording sheet ejection tray 3 which receives a recording sheet bearing the printed content of a record concerning facsimile apparatus transmission and reception, recording sheet supply tray 4 which supplies the aforementioned recording sheet, and operating panel 5 which provides instructions, etc. concerning the operation of the facsimile apparatus.

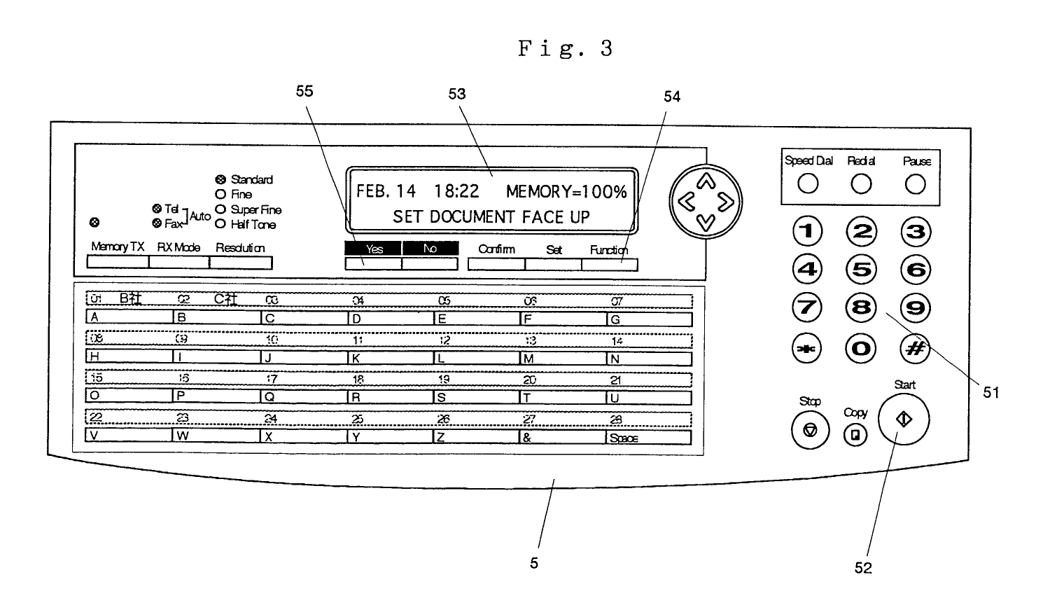

FIG. 3 is a component drawing of the operating panel in FIG. 2. Operating panel 5 includes keypad 51 which is operated to input telephone numbers and various other data, start key 52 which is operated to instruct the facsimile apparatus to initiate actions, display 53 which displays messages concerning facsimile apparatus operations or actions, function key 54 which is operated to instruct the facsimile apparatus with regard to a desired mode, and YES key 55 which is operated to indicate confirmation of instructional input for operations.

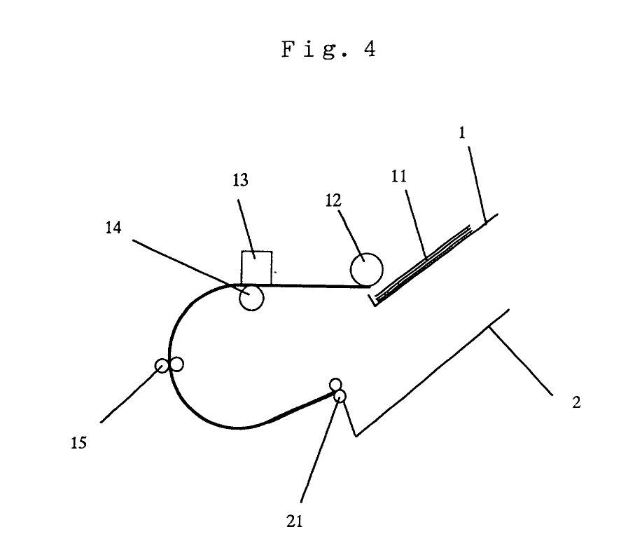

FIG. 4 is a component drawing of scanner elements provided internally in the facsimile apparatus pertaining to FIG. 2. Scanner elements in the drawing include sheet supply roller 12 which supplies to the interior of the facsimile apparatus original document for transmission 11 placed in original document supply tray 1, image sensor 13 and reading roller 14 which scan and thereby read an image on original document 11 while transporting the same, transport rollers 15 which transport original document 11 within the facsimile apparatus, and ejection rollers 21 which transport original document 11 from the interior of the facsimile apparatus to original document ejection tray 2.

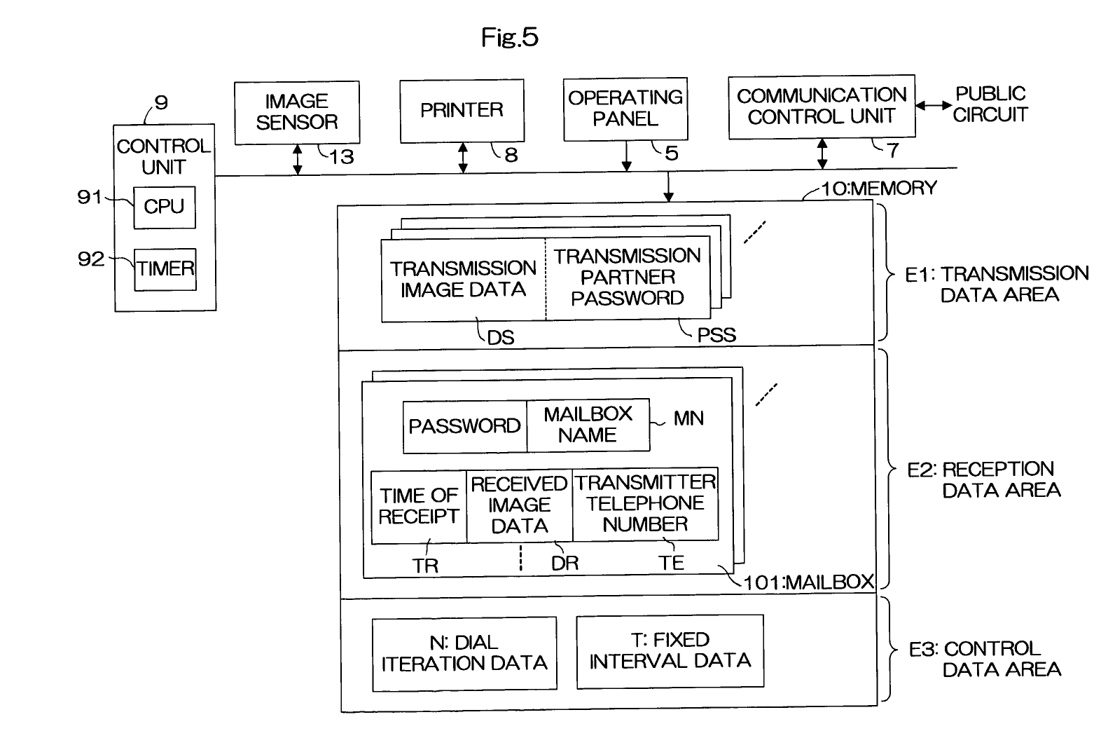

FIG. 5 is an internal block diagram concerning control of the facsimile apparatus pertaining to FIG. 2. The facsimile apparatus possesses control unit 9 which includes CPU 91 used for control and timer 92 which keeps the current time; and control unit 9 controls operating panel 5, communications control unit 7 which provides an interface to a public circuit, printer 8 used for print output, memory 10, and image sensor 13.

Memory 10 includes transmission data area E1, reception data area E2, and control data area E3. Transmission data area E1 stores multiple sets of confidential transmitted transmission image data DS in a manner corresponding to transmission partner passwords PSS which specify a transmission partner. Reception data area E2 provides multiple mailboxes 101 which store received data, and in each mailbox 101 is stored mailbox name MN, and password PSD which specifies said mailbox and provides access permission. Confidential received image data DR addressed to a said mailbox 101 is stored in a manner corresponding to its time of receipt TR and its transmitter telephone number TE. Control data area E3 stores control data which notifies a sender that confidential received image data has not been retrieved when such an instance occurs. In other words, control data area E3 stores dial iteration data N which designates a maximum number of redials to be performed until the sender receives said notification, and fixed interval data T which indicates the elapsed time from the arrival of the image data and serves as a basis for assessing whether or not to notify the sender that said image data has not been retrieved.

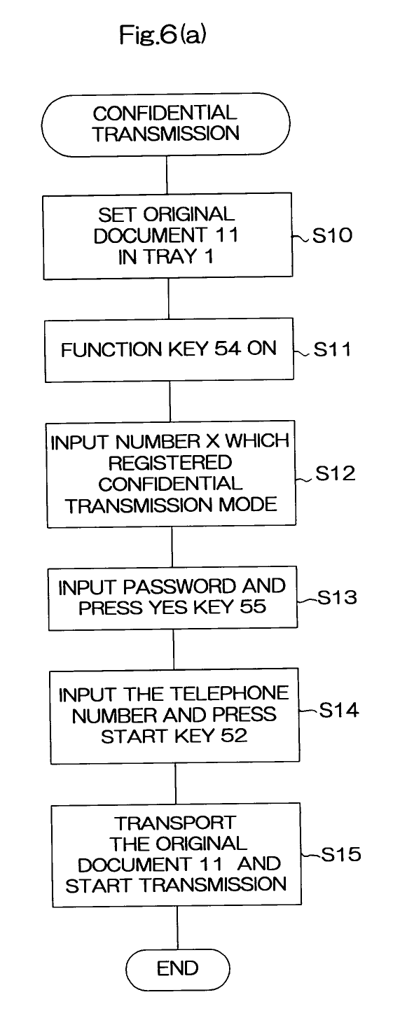

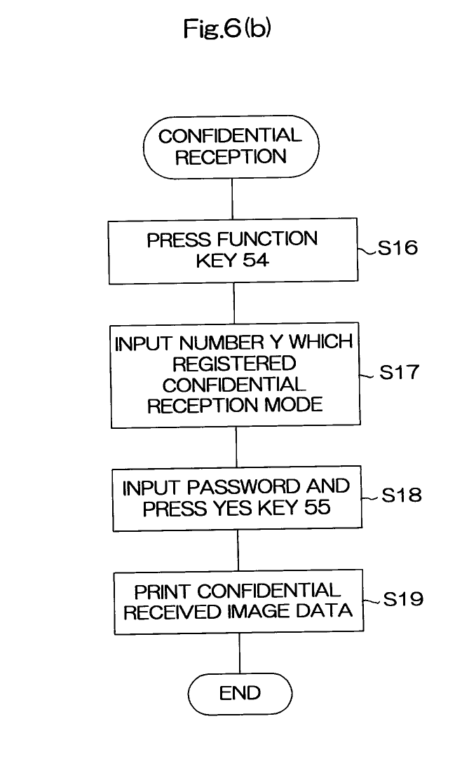

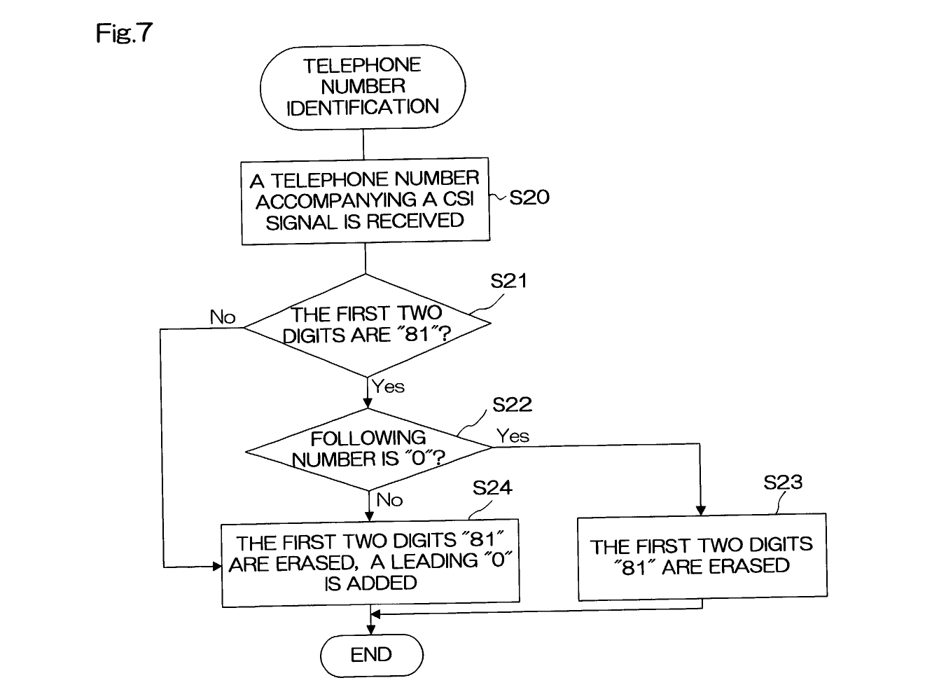

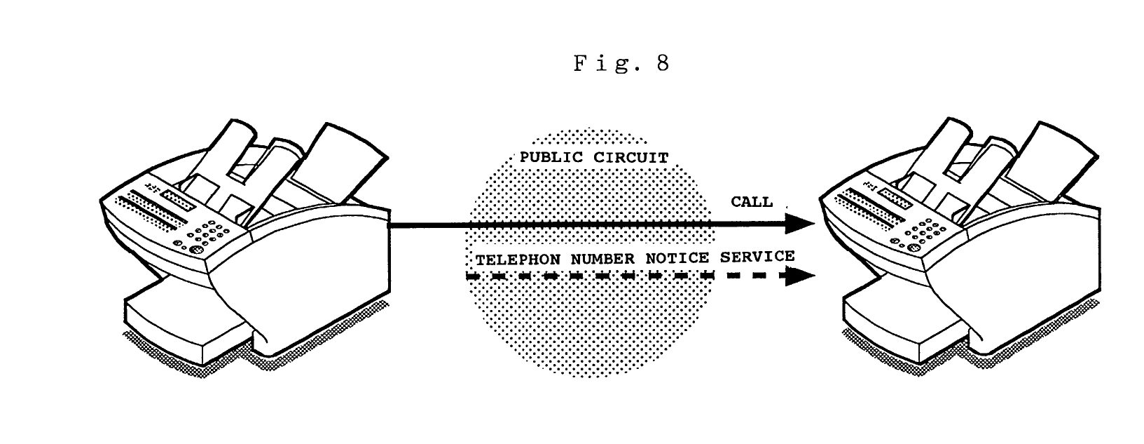

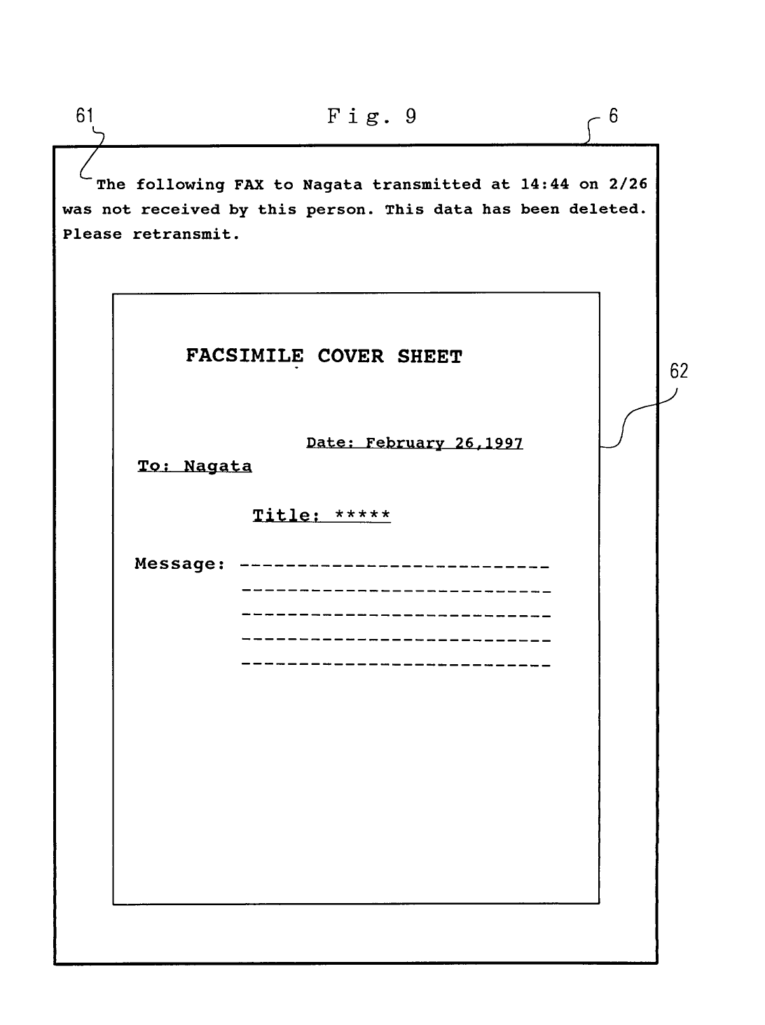

FIG. 6(a) is a processing flowchart concerning confidential transmission by the facsimile apparatus pertaining to FIG. 2. FIG. 6(b) is a processing flowchart concerning confidential reception by the facsimile apparatus pertaining to FIG. 2. FIG. 7 is a processing flowchart concerning telephone number recognition by the facsimile apparatus pertaining to FIG. 2. FIG. 8 is a drawing illustrating calling telephone number display service using a public circuit pertaining to FIG. 5. FIG. 9 is a drawing illustrating a data sheet used for notification that a confidential received image has not been retrieved by means of the facsimile apparatus pertaining to FIG. 2.

When confidential image data is transmitted between facsimile apparatuses pertaining to FIG. 2, as shown in FIG. 6(a), a user first places original document 11 in original document supply tray 1 (S10), and when function key 54 on operating panel 5 is pressed (S11), an instruction is issued allowing input of a function number, and the user uses keypad 51 to input number X to which a confidential transmission mode has been previously registered (S12). Display 53 then directs the user to input a password, and the user inputs a password by means of keypad 51 and presses YES key 55 (S13). At this stage, preparations for confidential transmission are complete, and the user inputs the telephone number of an intended recipient and presses start key 52. Original document 11 lying in original document supply tray 1 is then picked up by sheet supply roller 12, and transport begins (S15).

Image data of original document 11 obtained through photoelectric conversion by image sensor 13 is then compressed and temporarily stored in transmission data area E1 of memory 10 within the facsimile apparatus, in the form of transmission image data DS, and in a manner corresponding to a previously input transmission partner password PSS. The intended recipient is then dialed, and if a response is received from the intended recipient, a signal is sent indicating that the transmission is a confidential transmission. If this signal is received and a signal indicating permission is obtained from the intended recipient, transmission partner password PSS is first transmitted, and transmission of the corresponding transmission image data DS is then initiated.

The facsimile apparatus on the recipient side stores the received image data in a mailbox 101 designated by password PSS. Specifically, the data is stored as confidential received image data DR in a mailbox 101 possessing password PSD corresponding to received password PSS. A report indicating that confidential reception has taken place is then printed on a recording sheet and ejected into recording sheet ejection tray 3. Confidential received image data DR is then stored in reception data area E2 on the reception side, together with time of receipt TR recorded by timer 92 and transmitter telephone number TE. The method for identifying transmitter telephone number TE is discussed below.

When confidential received image data DR is retrieved from memory 10 on the reception side, as shown in FIG. 6(b), a user first presses function key 54 on operating panel 5 (S16), the user is then instructed to input a function number as in the case of confidential transmission, and keypad 51 is used to input number Y to which a confidential reception function has been previously registered (S17). Display 53 next instructs the user to input a password, and the user inputs a password by means of keypad 51 and presses YES key 55 (S18). Confidential received image data DR is subsequently read from a mailbox 101 which corresponds to the password input to the facsimile apparatus, in other words, that mailbox 101 which corresponds to a password PSD matching the input password. Confidential received image data DR thus read is printed on a recording sheet transported from recording sheet supply tray 4, and the recording sheet bearing the printed data is ejected into recording sheet ejection tray 3 (S19). A user can thereby acknowledge confidential received image data DR.

This feature termed confidentiality requires that a user who knows a password input the password in order to retrieve data from memory 10. In the event that a user who knows the password has not retrieved said confidential received image data DR from memory 10 for a long interval, or cannot retrieve the data due to absence or the like, confidential received image data DR cannot be permanently deleted from memory 10. The usable capacity of memory 10 for other various modes is thus restricted, and some modes become unusable. Storage area for other received image data is also restricted. When confidential received image data DR is simply removed from memory 10 in order to avoid this situation, the sender can no longer ascertain whether said confidential data arrived, or whether it was retrieved and acknowledged by the other party.

Thus, when the facsimile apparatus pertaining to the present preferred embodiment performs confidential reception, time of receipt TR, the relevant image data DR, and transmitter telephone number TE are stored in a mailbox 101 corresponding to reception data area E2. At such time, transmitter telephone number TE is identified as transmitted data accompanying a CSI signal. Because such data is at times an international telephone number including the Japanese country code “81,” the sender would not be reached if this number were dialed without modification. For this reason, the transmitter telephone number is identified according to the flowchart shown in FIG. 7.

When transmitted data accompanying a CSI signal is received (S20), a determination is made as to whether the first 2 digits are the Japanese country code “81” (S21), and if not (S21: NO), the data is identified as the telephone number of the other party.

If the first two digits are instead “81” (S21: YES), a determination is made as to whether the following number is [0] (S22). This is because a transmitter telephone number such as 053-388-1234 is sometimes registered as 81533881234. A determination is made as to whether the number following 81 is [0] (S22), and if not (S22: NO), the first two digits “81” are erased, a leading [0] is added, and this data becomes transmitter telephone number TE (S24). If the following number is [0] (S22: YES), the first two digits are erased, and this data becomes transmitter telephone number TE (S23). In either case, the designated transmitter telephone number TE is then stored together with confidential received image data DR in the corresponding mailbox 101.

Transmitter telephone number TE can also be learned easily through use of the calling telephone number display service offered by a public circuit, as shown in FIG. 8.

In the facsimile apparatus pertaining to FIG. 2, the elapsed time of recording (storage) in mailbox 101 is determined based on time of receipt TR for confidential received image data DR. If this exceeds previously set fixed interval data T, data sheet 6 like that shown in FIG. 9 is prepared and transmitted to the sender, indicating that confidential transmitted data has not been retrieved. Specifically, dialing is performed using transmitter telephone number TE stored in the relevant mailbox 101, and data sheet 6 is transmitted. If transmission ends without error, time of receipt TR, image data DR, and transmitter telephone number TE within the relevant mailbox 101 are erased, memory 10 is freed to allow usage by other modes, and processing ends. If a transmission error pertaining to data sheet 6 occurs at such time due to a busy line or the like, redialing is carried out only to the extent of previously set dial iteration data N. Data sheet 6 can thereby be transmitted to the sender reliably to provide notification that confidential image data was not retrieved. The course of this processing is described with reference to the flowchart in FIG. 1.

FIG. 1 is a flowchart wherein image data not retrieved in a fixed interval is deleted in the case of confidential reception. As described above, the interval stored in mailbox 101 is assessed based on time of receipt TR and the current clock time according to timer 92. If the elapsed time since receipt during which retrieval has not been performed reaches fixed interval data T, the sender is notified that the relevant confidential received image data DR has not been retrieved. First, variable n which counts the aforementioned number of redials is initially set to [0] (S1). Variable n is then increased by 1, and transmitter telephone number TE is used to dial the sender (S2, S3). Data sheet 6 like that shown in FIG. 9 is then prepared and bears a printout of data 61 stating that reception was unsuccessful. As shown in FIG. 9, data sheet 6 includes part or all 62 of confidential received image data DR, and data sheet 6 is transmitted to the sender (S4, S5).

A determination is then made as to whether the transmission of data sheet 6 ended without error (S6), and if so (S6: YES), data related to said confidential received image data DR (time of receipt TR, confidential received image data DR, and transmitter telephone number TE) is deleted from memory 10 (S7). If an error arose during transmission of data sheet 6 in FIG. 9, the sender did not receive data sheet 6 successfully (S6: NO), and retransmission is performed. At such time, a determination is made as to whether the number of redials n to the sender exceeds dial iteration data N (S8), and if n is less than dial iteration data N, transmission processing pertaining to data sheet 6 in steps S2-S6 is repeated. If the number of redials n exceeds dial iteration data N, processing ends, and data deletion at step S7 is not performed.

FIG. 9 is a specific example of data sheet 6, which is a report providing notification that a confidential received image has not been retrieved.

Data sheet 6 bears a printout of both prepared data 61, which is message data providing notification that a confidential received image has not been output, and confidential received image data 62. An example of message data prepared and printed as prepared data 61 is as follows: “The following FAX to Nagata transmitted at 14:44 on 02/26 was not received by this person. This data has been deleted. Please retransmit.” As in this example, elements of prepared data 61 include confidential image date and time information (the date and time of confidential image reception), confidential image addressee information, information stating that the confidential image was not received, information providing notification that the confidential image was erased, and a request for retransmission.

Prepared data 61 on data sheet 6 in FIG. 9 indicates the name of the addressee “Nagata” addressed by the sender, and this can be displayed by using a mailbox name MN registered to correspond to password PSD in the relevant mailbox 101. If only prepared data 61 in FIG. 9 were printed on data sheet 6 and transmitted to the sender, the sender would in some cases be unable to specify the confidential received image data DR that was not retrieved. Thus, part or all 62 of confidential received image data DR, which was confidentially received but not retrieved and therefore deleted, is printed on data sheet 6 and transmitted together with prepared data 61, which allows the sender to specify easily the confidential image data that was not retrieved.

As described above, management of the elapsed time from the arrival of confidential received image data DR allows effective use of memory 10 by deleting confidential received image data DR and data related thereto from memory 10 when said data is not retrieved during a fixed interval after its arrival. Confidential received image data DR is also deleted upon transmission of notification data to the sender, which informs the sender reliably that said confidential image data has not been retrieved, even if the confidential image data is erased on the recipient side. In such an instance, the sender can retransmit the confidential image data or take other such appropriate measures.

Part of the notification data also includes confidential received image data DR that was not retrieved, which allows the sender to ascertain reliably what said image data is in specific terms, and which also allows the sender to retransmit said image data or to take other appropriate action quickly.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. A facsimile apparatus provided with a confidential reception function, comprising:
a memory which stores received confidential image data;
a notification data transmission means for transmitting notification data indicating that the confidential image data has not been retrieved, in the event that the confidential image data stored in the memory area has not been retrieved in a predetermined time; and
a deletion means for deleting the confidential image data from the memory in response to the completion of transmission of said notification data by the notification data transmission means.

2. A facsimile apparatus as claimed in claim 1,
wherein said notification data includes at least a part of the confidential image data.

3. A facsimile apparatus as claimed in claim 1,
wherein said notification data includes a time information of the confidential image data transmission.

4. A facsimile apparatus as claimed in claim 1,
wherein said notification data includes an addressee information of the confidential image.

5. A facsimile apparatus as claimed in claim 1,
wherein said notification data includes an information providing notification that the confidential image was erased.

6. A facsimile apparatus as claimed in claim 1, further comprising:
a retransmission means for re-transmitting the notification data when the transmission of the notification data is not completed successfully.

7. A facsimile apparatus as claimed in claim 6, further comprising:
a prohibiting means for prohibiting said deletion of the confidential image when the transmission of the notification data is not completed after predetermined times of said retransmission.

8. A facsimile apparatus as claimed in claim 1, further comprising:
a identification means for identifying transmitter telephone number based on transmitted data;
wherein said memory stores the transmitter telephone number in connection with the confidential image.

9. A facsimile apparatus as claimed in claim 8,
wherein said notification data transmission means transmits the notification data using the identified telephone number by the identification means.

10. A facsimile apparatus as claimed in claim 1,
wherein said memory stores the time of receipt of the confidential image in connection with the confidential image.

11. A facsimile apparatus provided with a confidential reception function, comprising:
a memory which stores received confidential image data;
an output means for outputting the stored confidential image data in response to input of a password by an operator;
a determination means for determining whether or not the confidential image data has been output by the output means within a predetermined time after its reception;
a notification data transmission means for transmitting notification data indicating that confidential image data has not been output, in the event that the determination means has determined that output of the confidential image data has not been performed;
a detection means for detecting proper completion of transmission of the notification data; and
a deletion means for deleting the confidential image data from the memory in response to detection by the detection means.

12. A facsimile apparatus as claimed in claim 11,
wherein said notification data includes at least a part of the confidential image data.

13. A managing method for a confidential received image in a facsimile apparatus provided with a confidential reception function, comprising the steps of:
receiving confidential image data and storing the image data in a memory;
monitoring whether the stored confidential image data has been output within a predetermined time after the reception;
transmitting notification data indicating that output has not occurred, in the event that output has not occurred within the predetermined time;
detecting proper completion of transmission of the notification data; and
deleting the confidential image data from the memory in response to the detection.

14. A managing method as claimed in claim 13,
wherein said notification data includes at least a part of the confidential image data.
